(19) United States
(12) Patent Application Publication
(10) Pub. No.: US 2025/0173629 A1
(43) Pub. Date: May 29, 2025

(54) SYSTEMS AND METHODS FOR RULE AGNOSTIC REJECT INFERENCING

(71) Applicant: PayPal, Inc., San Jose, CA (US)

(72) Inventors: Parthasarathy Subburaj, Chennai (IN); Mahesh Balan Umaithanu, Chennai (IN); Ashish Kumaraswamy, Coimbatore (IN); Venkata Subramanian Selvaraj, Chennai (IN)

(21) Appl. No.: 18/521,190

(22) Filed: Nov. 28, 2023

(51) Int. Cl. G06N 20/20; G06F 18/2415

(52) U.S. Cl. CPC G06N 20/20; G06F 18/2415

(57) ABSTRACT

There are provided systems and methods for rule agnostic reject inferencing. An example method may receive a request for processing a transaction, and determine, using a machine learning model, a classification for the transaction based on data associated with the transaction. The machine learning model may be trained using first training data having verified labels and second training data having inferred labels, and the inferred labels of the second training data may be generated based on a distribution of classifications associated with the first training data. The example method may further process the request based on the classification.

### TECHNICAL FIELD

The present application generally relates to a framework for training a machine learning model, and more specifically, to generating training data for training a machine learning model configured to perform a classification task.

### BACKGROUND

When building a machine learning model for performing a classification task (e.g., transaction classification such as fraudulent transaction detections, credit underwriting, credit fraud detection, or other data classification tasks), training datasets used for training such a machine learning model may include previously processed transactions that have been labeled with verified classifications (e.g., whether a transaction is fraudulent or not) determined based on actual results from processing of the transactions. For example, when the application of a previously approved credit application turned out to be a good credit applicant (e.g., always pay on time, etc.), that previously approved credit application is labeled with a “good” application label. On the other hand, when the applicant of a previously approved credit application turned out to be a bad applicant (e.g., multiple late payments, missed payments, defaults, etc.), that application is labeled with a “bad” application label. Since previously declined transaction attempts (e.g., previous declined applications) were never processed, records associated with any previously declined transactions are typically excluded from the training data due to the lack of verified labels. However, training the machine learning model based only on the approved applications cannot be representative of actual applications in reality, because the actual applications include both of the approved applications and declined applications. As a result, a model trained with this incomplete data may not yield optimal or accurate outputs or predictions.

As such, a framework for training a machine learning model using more efficient (e.g., resource usage efficiency), accurate, and objective training data is desirable.

### BRIEF DESCRIPTION OF THE DRAWINGS

FIG. 1 is a block diagram illustrating an exemplary system according to an embodiment of the present disclosure;

FIG. 2 illustrates an exemplary diagram of a framework for training a machine learning model for reject inferencing according to an embodiment of the present disclosure;

FIG. 3 illustrates an exemplary diagram of distributions of first and second classifications according to an embodiment of the present disclosure;

FIG. 4 illustrates an exemplary diagram of inferring a label and a weight for a transaction according to an embodiment of the present disclosure;

FIG. 5 illustrates an exemplary diagram of a process training a machine learning model for reject inferencing according to an embodiment of the present disclosure;

FIG. 6 is a flowchart showing a process of a process for reject inferencing on a request according to an embodiment of the present disclosure; and

FIG. 7 is a block diagram that illustrates an exemplary of a computing device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for training a machine learning model using rule agnostic reject inferencing to improve the accuracy performance of the machine learning model configured to perform a transaction classification task. The techniques disclosed herein can be flexibly applied to machine learning model configured to classify different types of transactions, such as detecting fraudulent payment transactions, underwriting credit application transactions, detecting fraudulent chargeback transactions, etc. In some embodiments, the system of the present application may include a multi-model architecture framework for building a machine learning model. By utilizing the multi-model architecture to build and train the machine learning model, the trained machine learning model may efficiently and accurately determine a classification for a transaction without resource waste and subjective errors.

When a system receives a request of processing a transaction (e.g., applying for a credit card or applying for a loan, a payment transaction, a purchase transaction, a chargeback transaction, etc.), a fraud model and a credit model (either or both models can be a machine learning model) running in the system may examine the transaction based on data extracted from the request, and determine whether the transaction is likely to be fraudulent or not, such that the system may process the request accordingly, such as approving, declining, or requesting additional authentication for the transaction. For example, the fraud model may firstly examine whether the transaction is likely to be fraudulent, and if the transaction has passed the examination of the fraud model, the request may be sent to the credit model for a further examination. If the transaction has not passed the examination of the fraud model, the request may be declined. Furthermore, the credit model may examine those requests that have passed the examination of the fraud model, e.g., a credit check, and if the transaction has passed the examination of the credit model, the request may be approved, and the transaction may be processed. If the transaction has not passed the examination of the credit model, the request may be declined. In other embodiments, further data can be requested from the user submitting the transaction, including financial data, authentication data, and the like. Thus, the transaction may not be approved or denied initially, but after additional processing. The approved transactions may be assigned with a “good” label or a “bad” label (e.g., by a 1 or 0, respectively, or any other identifier) by applying rules to them based on observed activities after the transaction was processed. The “good” label may indicate that this approved transaction is a true, non-fraudulent transaction, and the “bad” label may indicate that this approved transaction ended up being a fraudulent transaction. For example, an approved transaction may be assigned with a “bad” label if an account through which the transaction was conducted has been restricted due to suspicious activities within a period of time (e.g., the past three months, etc.). For a payment transaction, the system may check if the payment was refunded in a period of time, or if a chargeback event has occurred. If any preset malicious activities have been observed, the payment transaction that had been approved previously may be assigned with a “bad” label. Likewise, for a credit application, the system may check if there has been any late or missed payments after the credit application was approved, and the credit application may be assigned with a “good” label if none of the fraudulent activities has been observed, e.g., no late or missed payments. Furthermore, for an onboarding transaction, the system may monitor the account to see if the account was suspended due to suspicious activities after the account was created, such that the system may assign a “bad” label to the onboarding transaction if any suspicious activities has been observed.

As discussed above, transactions that are rejected by either the fraud model or the credit model may never be processed, and are referred to as declined transactions. Since these declined transactions were never processed, the transactions are never associated with any observable activities on which a determination of whether the transactions are actually good or bad can be based. In order to include the declined applications when training the machine learning model, rules can be applied to these declined transactions to infer labels. Rules for inferring a “good” label or a “bad” label for the declined applications may be defined by an administrator of the service. The “good” label may indicate that this declined transaction is a true, non-fraudulent transaction, and the “bad” label may indicate that this declined transaction is a true, fraudulent transaction. For example, an administrator of the service for processing a request of underwriting may set up a set of rules to examine the declined transactions and infer labels for them based on the set of rules. One of the rules used in inferring labels may be “assigning a “good” label when there are no fraud transactions conducted through an account associated with the transaction request in the past 45 days after the underwriting of the transaction request,” and a declined application that complies with the rule may be inferred with the “good” label. However, the rules defined in the reject inferencing method cannot accurately categorize the entire set of declined applications, e.g., a declined application that does not fall in any of the categories defined by the rules would go to an indeterminate category and remains unlabeled. As such, it is possible that a majority of the declined transactions are not categorized and remain unlabeled, because the majority of the declined transactions cannot be defined by existing rules. For example, a rule for inferring a “good” label for a declined request of applying for a credit card may be “the user associated with the credit card application transaction having five successful transactions using another credit card of the same user, and no fraud restrictions in the first 45 days after the credit card application transaction was declined,” and any declined transactions comply with this rule may be assigned with the “good” label. In addition, there may be another rule for inferring a “bad” label that “for an account through which the declined transaction was initiated, a fraud restriction imposed and not lifted in the first 45 days after the transaction was declined,” and any declined transactions that satisfy this rule may be assigned with the “bad” label. Any declined transactions that do not comply with any of the rules may be categorized as indeterminate and may not be assigned with any labels. Since reject inferencing using rules cannot cover all declined transactions, available data points are wasted significantly. Furthermore, applying rules to infer labels is subjective in nature which leads to errors in the outcome of the trained machine learning model, such as approving a fraudulent transaction from a user that had few successful transactions.

Therefore, the present application provides a multi-model framework for generating training data for training a machine learning model using non-rule-based reject inferencing. The framework may generate training data using both previously approved transactions and previously declined transactions. The present application also provides systems and methods for inferring labels and weights for the declined transactions without using any rules. The system may first generate and train a first machine learning model (referred to hereinafter an “ML1” model) using the approved transactions which have verified labels. The verified labels may be labels that have been validated, e.g., a past transaction that has been processed and reported as a non-fraudulent approved transaction, may be assigned with a “good” label which is a verified label. After training the ML1 model, the system may use the trained ML1 model to classify each of the declined transactions. In some embodiments, the ML1 model may be configured to output a score based on attributes associated with each transaction. The score output by the trained ML1 model may be a score that indicates a likelihood that a transaction is fraudulent or not, so that the score may be advantageously used to infer labels and weights for the declined transactions. In some embodiments, the score may be a fraud probability of a transaction.

The system may use the ML1 model to generate scores for the approved transactions. Based on the scores generated for the approved transactions, the system may determine one or more cutoff points for inferring a “good” label or a “bad” label for the declined transactions. In some embodiments, the method may generate a distribution of scores generated by the ML1 model for approved transactions that are labeled as “good” (e.g., non-fraudulent approved transactions), such that a score, e.g., which the administrator sets, where a certain percentage of the non-fraudulent approved transactions is, or where the most population of the non-fraudulent approved transactions is, may be a reliable threshold to infer the “good” label for the declined transactions. For example, a declined transaction that has a score lower than the “good” cut off point (e.g., having a lower probability to be a fraud) may be assigned with a “good” label. Furthermore, the method may generate another distribution of scores generated by the ML1 model for approved transactions that are labeled as “bad” (e.g., fraudulent approved transactions), such that a score, e.g., which the administrator sets, where a certain percentage of the fraudulent approved transactions is, or where the most population of the fraudulent approved transactions is, may be a reliable threshold to infer the “bad” label for the declined transactions. For example, a declined transaction that has a fraud probability higher than the “bad” cutoff point (e.g., having a higher probability to be a fraud) may be assigned with a “bad” label.

For those declined transactions that have a score that cannot be inferred with a “good” label or a “bad” label based on the two cutoff points (e.g., transactions having scores between the “good” cut off point and the “bad” cut off point, etc.), the systems and methods disclosed in the present application may further perform an oversampling based on those transactions, and may compute an adaptive weight for each of the oversampled transaction. In this regard, each of those declined transactions may be assigned with both a “good” label and a “bad” label, and their adaptive weights corresponding to the “good” label and the “bad” label may indicate a level of inclination towards to the “good” label and the “bad” label respectively.

Using training data generated based on the approved transactions that have the verified labels and the declined applications that have the inferred labels and the computed weights, the systems and methods disclosed in the present application may train another machine learning model (also referred to an “ML2” model). By utilizing the trained ML2 model, a classification (e.g., an approved classification or a declined classification) of a transaction may be provided. The trained ML2 model of the present application are trained based on the entire population of the transactions (including the approved transactions and the declined transactions), the accuracy of the trained ML2 model may be improved, and useful transaction records may be properly utilized. Furthermore, the method of the present application provides an objective, reliable approach to infer labels and compute weights for each of the transactions that do not have a verified label, the performance of the trained ML2 model may be improved by reducing subjective errors. Alternatively, the method for inferring labels and weights discussed in the present application may be applied to preparing any training datasets that have not been labelled in response to any training purpose, e.g., a decision-making service.

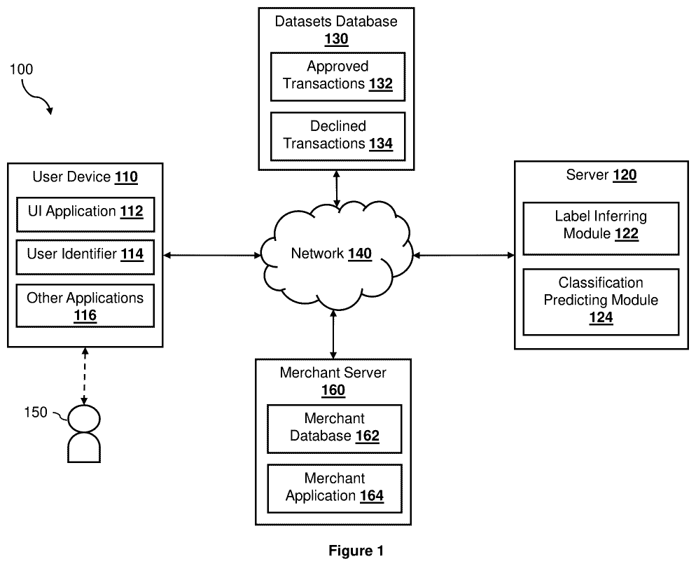

FIG. 1 illustrates an exemplary system 100, within which the multi-model framework for building and training a machine learning model using rule agnostic reject inferencing may be implemented, according to some embodiments of the disclosure. The system 100 includes a user device 110, a server 120, a datasets database 130, and a merchant server 160 that may be communicatively coupled with each other via a network 140. The datasets database 130, in one embodiment, may be a database storing a plurality of datasets for training various machine learning models (e.g., recurrent neural networks including long short-term memory (LSTM) network, natural language processing models including summarization, sentiment analysis, etc., and computer vision (CV) models including optical character recognition (OCR) and object detection) for performing certain tasks (e.g., determining a decision in response to a request associated with a service, etc.) which are accessible by the server 120. The server 120, in one embodiment, may include a label inferring module 122 for training the M1 model and a classification predicting module 124 for training the ML2 model e.g., a machine learning model for rule agnostic rejecting inferencing for requests sent from the merchant server 160. The merchant server 160 may implement products/services of a service provider which is provided by the server 120, and receive requests from the user device 110 initiated by a user 150. The network 140 may be implemented as a single network or a combination of multiple networks. For example, the network 140 may include the internet and/or one or more intranets, landline networks, wireless networks, and/or other appropriate types of communication networks. In another example, the network 140 may comprise a wireless telecommunications network (e.g., cellular phone network) adapted to communicate with other communication networks, such as the Internet.

The user device 110 may include a user interface (UI) application 112 (e.g., a web browser, a mobile payment application, a downstream application, etc.), which may be utilized by the user 150 to interact with the server 120 and/or the merchant server 160 over the network 140. The user interface application 112 may include a software program (e.g., a mobile application) that provides a graphical user interface (GUI) for the user 150 to interface and communicate with the server 120 via the network 140. In another implementation, the user interface application 112 may include a browser module that provides a network interface to browse information available over the network 140. For example, the user interface application 112 may be implemented, in part, as a web browser to view information available over the network 140. Thus, the user 150 may use the user interface application 112 to initiate electronic transactions (e.g., login transactions, data access transactions, payment transactions, credit applications, etc.) with the server 120 and/or the merchant server 160.

For example, the user 150 may, via the user device 110, log into their account and request a transaction (e.g., making a payment or accessing content) via the merchant server 160. The merchant server 160 may determine data associated with the transaction, such as data provided by the user 150 via the user device 110, data associated with the user device 110, and data associated with the user 150, and send the gathered data to the server 120 to be parsed and evaluated. For example, an administrator (which can be a human or a computer, such as a bot) of the merchant server 160 may have a need to identify whether the request is fraudulent. The administrator of the merchant server 160 may provide the gathered data to the server 120 for reject inferencing (e.g., predict a classification for the request). Based on the determined outcome (e.g., an approved class on the transaction included in the request) by the server 120, the merchant server 160 may process the request accordingly (e.g., completing the request based on the approval on the transaction).

The user device 110 may include other applications 116 as may be desired to provide additional features available to the user 150. In one example, such other applications 116 may include security applications for implementing client-side security features, programmatic client applications for interfacing with appropriate application programming interfaces (APIs) over the network 140, and/or various other types of generally known programs and/or software applications. In still other examples, the other applications 116 may interface with the user interface application 112 for improved efficiency and convenience.

The user device 110 may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the merchant server 160 via the network 140, and the identifier 114 may be used by the merchant server 160 to associate the user 150 with a particular user account (e.g., and a particular profile), a particular transaction, and/or a particular service at the merchant server 160.

In various implementations, the user 150 may be able to input data and information into an input component (e.g., a keyboard) of the user device 110. For example, the user 150 may use the input component to interact with the UI application 112 (e.g., to conduct a purchase transaction via the merchant server 160 and/or the server 120).

The datasets database 130 may store one or more datasets, for example, including training datasets for training various machine learning models (e.g., the ML1 and ML2 models discussed above) maintained by the server 120, including approved transactions 132 and declined transactions 134 in the past. The various machine learning models may be trained, built, and accessed by the server 120, and may be used by the server 120 for performing various tasks. For example, the server 120 may generate the training datasets based on the approved transactions 132, and the datasets database 130 may store the training datasets associated with the approved transactions 132 and the declined transactions 134 (e.g., account actions, transaction related data, historical transactions, etc.), datasets associated with users associated with the merchant server 160 (e.g., a user profile of the user 150 registered with the service provided at the merchant server 160) for analyzing a fraudulent transaction, so that the server 120 may train a machine learning model for reject inferencing or for a certain task using these training datasets store in the datasets database 130.

In some embodiments, the training datasets may include the approved transactions 132, e.g., historical transactions that have been approved by the fraud model and the credit model. Furthermore, the approved transactions 132 may include non-fraudulent approved transactions and fraudulent approved transactions. For example, a fraudulent approved transaction may be a transaction that has been approved by the fraud model and the credit model at first, and later been reported as a fraud, e.g., failure to complete a monthly payment after being approved of a credit card. This kind of fraudulent approved transaction may be assigned with a “bad” label to indicate that this transaction should have been declined. Likewise, a non-fraudulent approved transaction may be a transaction that has been approved by the fraud model and the credit model, and continuously remains a good record (e.g., paying off a monthly mortgage on time for at least six months). This kind of non-fraudulent approved transaction may be assigned with a “good” label to indicate that this transaction is a true approved transaction. In some embodiments, the training datasets may include declined transactions 134, e.g., historical transactions that have been declined by either the fraud model or the credit model. These declined transactions 134 may not have a label because they have never been processed/examined after being declined, but may include features and/or characteristics associated with the user 150, historical data associated with the declined transactions 134, data associated with the merchant, and the like for training a machine learning model for reject inferencing implemented in the classification predicting module 124.

The server 120 may be any of various types of computer servers, e.g., a cluster of computers in a server farm, capable of serving data to other computing devices, including the user device 110, the datasets database 130, and the merchant server 160, via network 140. The server 120 may be associated with different types of entities or systems, such as, but not limited to, various service providers, including payment or transaction service providers (e.g., PayPal®).

The label inferring module 122 and the classification predicting module 124 at the server 120 may retrieve datasets (e.g., training datasets including the approved transactions 132 and/or the declined transactions 134) and parse data in the datasets, and train a ML1 machine learning models and a ML2 model respectively. The ML1 model may be trained and implemented at the label inferring module 122 for outputting a score for a transaction. In some embodiments, the ML1 model may be trained using the approved transactions 132 that have verified labels (e.g., historical non-fraudulent approved transactions assigned with the “good” labels, and historical fraudulent approved transactions assigned with the “bad” labels, which are also stored in the database 130, for example) retrieved from the datasets database 130. The trained ML1 model may output a score for a transaction, e.g., the approved transactions 132 and the declined transactions 134. In some embodiments, the score may indicate a risk level and/or a fraud probability of the transaction. The scores of the approved transactions 132 generated by the ML1 model may be used to determine a threshold for inferring a “good” label and a threshold for inferring a “bad” label. For example, a computing algorithm implemented at the label inferring module 122 may generate a distribution based on the scores of the non-fraudulent approved transactions, such that the distribution may indicate a population distribution of the non-fraudulent approved transactions according to their scores. In some embodiments, a “good” threshold for inferring a “good” label may be a score which the administrator sets up, where a certain percentage of population of the non-fraudulent approved transactions is, where the most population of the non-fraudulent approved transactions is, or an approach that may determine a reliable threshold for inferring the “good” label. Any declined transaction that has a score lower than the “good” threshold may be reliable to be inferred with the “good” label. Likewise, the computing algorithm implemented at the label inferring module 122 may further generate a distribution based on the scores of the fraudulent approved transactions, such that the distribution may indicate a population distribution of the fraudulent approved transactions according to their scores. A “bad” threshold for inferring a “bad” label may be a score which the administrator sets up, where a certain percentage of population of the fraudulent approved transactions is, where the most population of the fraudulent approved transactions is, or an approach that may determine a reliable threshold for inferring the “bad” label. Any declined transaction that has a score higher than the “bad” threshold may be reliable to be inferred with the “bad” label.

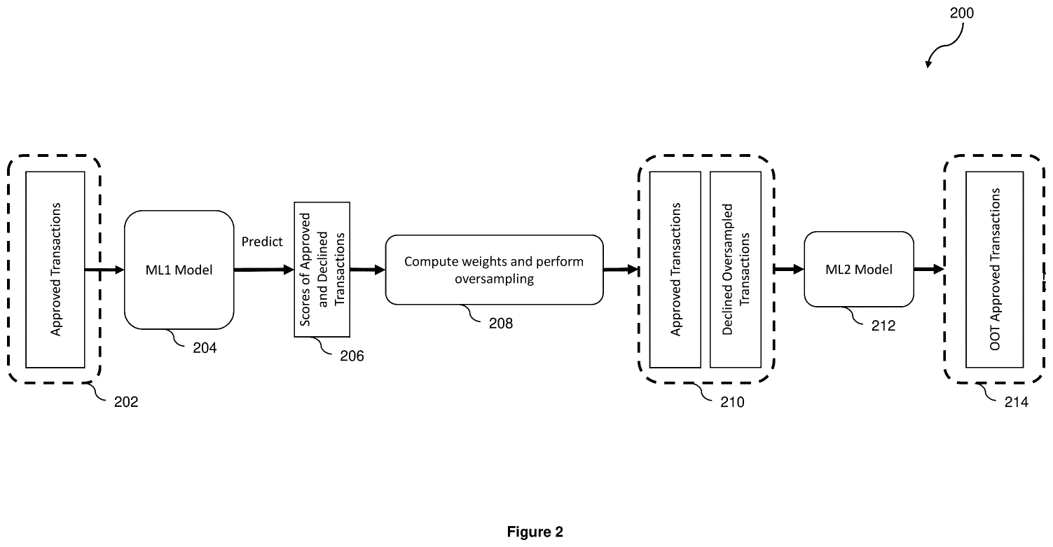

Furthermore, the scores for the “good” threshold and the “bad” threshold may also be used to compute a weight for a transaction corresponding to its inferred label. For those transactions that may not be labeled based on the “good” threshold or the “bad” threshold, especially those declined transactions that have not been inferred with any labels, the computing algorithm implemented at the label inferring module 122 may perform oversampling and compute weights for these declined transactions. For example, the declined transactions that have a score between the “good” threshold and the “bad” threshold may be assigned with both of the “good” label and the “bad” label, and for each label, a corresponding weight may be calculated based on a level of inclination towards the “good” label or the “bad” label. In some embodiments, those declined transactions that have a score between the “good” threshold and the “bad” threshold may be duplicated, such that the computing algorithm implemented at the label inferring module 122 may generate two training records for such declined transactions, e.g., one training record with the “good” label, and another training record with the “bad” label. For the training record with the “good” label, the computing algorithm implemented at the label inferring module 122 may compute a weight based on how close its score is to the “good” threshold. And for the training record with the “bad” label, the computing algorithm may compute a weight based on how close its score is to the “bad” threshold. In this regard, the weights and their corresponding labels may properly and accurately indicate a fraud probability of such a declined transaction, and hence improve the performance of the ML2 model. The actions and the approaches related to the label inferring module 122 of the server 120 will be further described in detail in FIGS. 2-7.

By using the approved transactions 132 with the verified labels and the declined transactions 134 with the inferred labels and the corresponding weights, the ML2 model may be trained using the entire population of the transactions, which is ideal and correctly reflects the reality when training a machine learning model for reflect inferencing. The trained ML2 model may be then implemented at the classification predicting module 124 for determining a classification for a transaction. The trained ML2 model may output a classification (e.g., an approved class or a declined class) for a transaction based on data associated with the transaction. In some embodiments, the determined classification for the transaction may be sent to the merchant server 160 for further processing. The actions and the approaches related to the classification predicting module 124 of the server 120 will be further described in detail in FIGS. 2-7.

The merchant server 160 may be maintained by a business entity (or in some cases, by a partner of a business entity that processes transactions on behalf of the business entity). Examples of business entities include merchants, resource information providers, utility providers, online retailers, real estate management providers, social networking platforms, subscription services, a cryptocurrency brokerage platform, etc., which offer various items, services, and content for purchase and process payments for the purchases. The merchant server 160 may include a merchant database 162 for identifying available items or services, which may be made available to the user device 110 for viewing and purchase by the respective users.

The merchant server 160 may include a merchant application 164, which may be configured to provide information over the network 140 to the server 120 and/or the user interface application 112 of the user device 110. The merchant application 164 may include a web server that hosts a merchant website for the merchant. For example, the user 150 of the user device 110 may interact with the merchant application 164 through the user interface application 112 over the network 140 to search and view various items or services available for purchase in the merchant database. While only one merchant server 160 is shown in FIG. 1, it has been contemplated that multiple merchant servers, each associated with a different merchant, may be connected to the user device 110 and the server 120 via the network 140.

In some embodiments, the merchant server 160 may receive a request of processing a transaction from the user device 110 and then forward the request and potentially data associated with the request to the server 120 for the server 120 to examine the request. The merchant server 160 may receive a classification for the transaction (e.g., an approved classification or a declined classification) determined by the server 120, and process the request based on the determined classification, e.g., completing a purchase of a product.

FIG. 2 illustrates an exemplary diagram 200 of a framework for training a machine learning model for reject inferencing, according to various embodiments of the disclosure. In some embodiments, the method discussed in the exemplary diagram 200 may be performed by the label inferring module 122 and the classification predicting module 124 of the server 120 (as shown in FIG. 1).

In a process of performing rule agnostic reject inferencing on a transaction, a ML1 model 204 may be firstly trained based on approved transactions 202 that have verified labels. In some embodiments, the ML1 model 204 may receive first training datasets including the approved transactions 202 (as the approved transactions 132 shown in FIG. 1) from the datasets database 130 and/or a database of the merchant server 160. The approved transactions 202 may be transactions that have been approved in the past (e.g., approved credit application transactions, approved payment transactions, approved chargeback transactions, etc.) and assigned with a label (e.g., a verified label/a true tag). In some embodiments, the approved transactions 202 may include non-fraudulent approved transactions that have been approved and have not been reported as a fraud afterwards and fraudulent approved transactions that have been approved but have been reported as a fraud afterwards. The non-fraudulent approved transactions may be assigned with a “good” label, and the fraudulent approved transactions may be assigned with a “bad” label. The ML1 model may then be trained based on the first training datasets, and a system (e.g., a system running by the server 120) may use the trained ML1 model to generate scores for the approved transactions 202 and also the declined transactions (which may correspond to declined transactions 134). In some embodiments, the system may have a computing algorithm that infers a label and computes a weight for each of the approved transactions and the declined transactions (as the declined transactions 134 shown in FIG. 1) based on the score generated by the ML1 model 204. For example, the system may use the scores generated for the approved transactions 202 by the ML1 model 204 to determine the cutoff points, which may then be used to infer the labels and weights for the declined transaction 134. The system may also use the scores generated by the ML1 model 204 for the declined transactions 134 to infer their labels and compute their weights. In some embodiments, the declined transactions 134 may be transactions that have been declined by the fraud model and/or the credit model. For example, the ML1 model may obtain a fraud probability for each of the declined transactions based on data associated with it.

In some embodiments, the ML1 model may obtain (at step 206) fraud probabilities for the approved transactions (e.g., the non-fraudulent approved transactions and the fraudulent approved transactions). Based on the fraud probabilities (e.g., the scores generated by the ML1 model) of the non-fraudulent approved transactions, a distribution of the scores for transactions labeled with a first classification may be generated. The first classification may correspond to the non-fraudulent approved transactions. In some embodiments, the score distribution of the approved transactions labeled with the first classification may indicate a proportion of the non-fraudulent approved transactions with different scores representing their fraudulent probabilities. Likewise, based on the fraud probabilities of the fraudulent approved transactions, a distribution of scores for transactions labeled with a second classification may be generated. The second classification may correspond to the fraudulent approved transactions. In some embodiments, the score distribution of the approved transactions labeled with the second classification may indicate a proportion of the fraudulent approved transactions with different scores representing their fraudulent probabilities.

With the score distributions corresponding to the first and second classifications, a first score threshold and a second score threshold for inferring the label and weight may be determined. For example, the distributions of the first and second classifications may indicate a cutoff point where a certain percentage of the population distribution is which may be reliable to be used for inferring the labels. In some embodiments, the cutoff point may have a highest density/count in the distribution. In some embodiments, the fraud probability that has the most population in the distribution of the first classification may be used as a first score threshold to assign a “good” label. For example, the highest density in the distribution of the first classification may correspond to a fraud probability of 0.3, such that the fraud probability of 0.3 may be used as the first score threshold, which means that a transaction that has a fraud probability lower than 0.3 may be assigned with a “good” label. Correspondingly, the fraud probability that has the most population in the distribution of the second classification may be used as a second score threshold to assign a “bad” label. For example, the highest density in the distribution of the second classification may correspond to a fraud probability of 0.7, such that the fraud probability of 0.7 may be used as the second score threshold, which means that a transaction that has a fraud probability exceeding 0.7 may be assigned with a “bad” label.

In some embodiments, the framework further includes a step of computing weights and performing oversampling 208 for transactions, e.g., the declined transactions that have a score between the first score threshold and the second score threshold, especially for declined transactions that have a fraud probability between the first score threshold and the second score threshold and have not been assigned with a “good” label or a “bad” label. For those declined transactions that have a fraud probability lower than the first score threshold, they may be assigned with a “bad” label with zero (e.g., a “good” label) and a weight of one. For those declined transactions that have a fraud probability exceeding the second score threshold, they may be assigned with a “bad” label with one (e.g., a “bad” label) and a weight of one. For the declined transactions that have a fraud probability between the first score threshold and the second score threshold, performing oversampling on these transactions may include duplicating each of these transactions, such that each transaction may have two records having the same transaction data. The framework may assign a “good” label to one of the records and assigning a “bad” label to the other one of the records. The framework may further assign corresponding adaptive weights to the records respectively. By oversampling, those declined transactions that have a fraud probability between the first score threshold and the second score threshold (e.g., transactions have not been assigned with a “good” label or a “bad” label) may be properly considered both the first classification and the second classification. Furthermore, with an adaptive weight assigned to each of the duplicated records, the transactions that have a fraud probability between the first score threshold and the second score threshold may improve the confidence level and accuracy for a trained machine learning model. In addition, the data resource (e.g., transactions that originally cannot be labelled via rules and/or transactions that have a fraud probability between the first score threshold and the second score threshold) may not be wasted and may provide more reliable reference when training a machine learning model for reject inferencing.

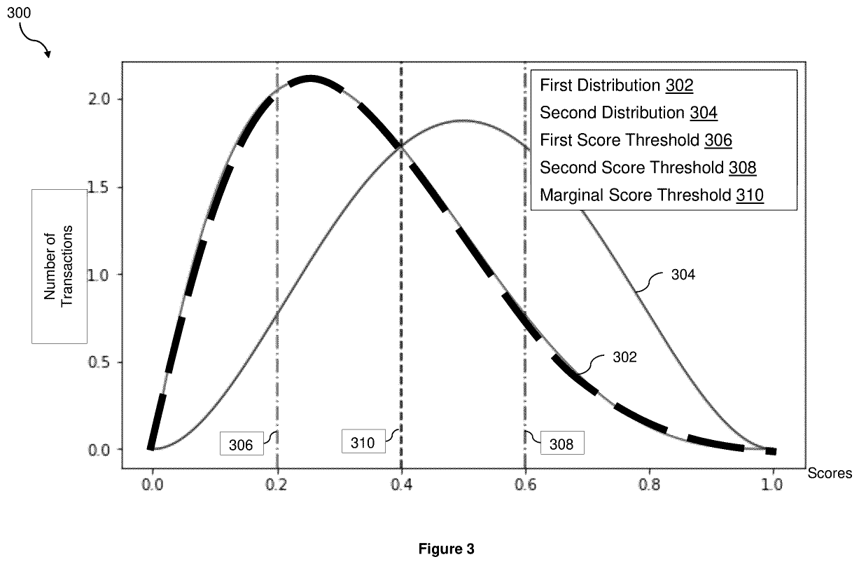

Once the declined transactions (including the declined oversampled transactions) are being assigned with labels and weights, the framework may generate new training data based on the approved transactions with the verified labels and the declined transactions with the inferred labels and weights. The framework may then use the new training data to train a ML2 model 212. The ML2 model may generate out-of-time (OOT) approved transactions (e.g., test data with a classification). In some embodiments, a trained ML2 model implemented at the classification predicting module 124 as shown in FIG. 1 may output a classification for a transaction (e.g., a request, an application, and/or a decision associated with a service), such as a first classification corresponding to approved transactions or a second classification corresponding to declined transaction. Therefore, a service provider or a merchant who implements the service may proceed with processing the transaction based on its classification determined by the trained ML2 model (e.g., guaranteeing a credit line included in the transaction or rejecting an application of a credit card). A further illustration of generating distributions of the first and second classifications will be explained in a diagram in FIG. 3.

FIG. 3 illustrates an exemplary diagram 300 of the score distributions of the first and second classifications, according to various embodiments of the disclosure. In some embodiments, the score distributions 300 may be generated using the scores generated by the ML1 model 204 based on the approved transactions 202. As shown in FIG. 3, the score distribution 300 includes an x-axis representing various scores (e.g., fraud probabilities) and a y-axis representing the number of transactions that correspond to the different scores. A first distribution 302 may be a distribution generated based on fraud probabilities of transactions in the first classification (e.g., the non-fraudulent approved transactions). A second distribution 304 may be a distribution generated based on fraud probabilities of transactions in the second classification (e.g., the fraudulent approved transactions). In some embodiments, the first distribution 302 and the second distribution 304 may be generated based on populations/number of transactions that correspond to the corresponding fraud probabilities. For example, the first distribution 302 in this example indicates that there are approximately 2 million non-fraudulent approved transactions having a score (e.g., a fraud probability) of 0.2 generated by the ML1 model 202, and approximately 1.6 million non-fraudulent approved transactions having a score (e.g., a fraud probability) of 0.4 generated by the ML1 model 202, and approximately 0.6 million non-fraudulent approved transactions having a score (e.g., a fraud probability) of 0.6 generated by the ML1 model 202. Similarly, the second distribution 304 in this example indicates that there are approximately 0.7 million fraudulent approved transactions having a score (e.g., a fraud probability) of 0.2 generated by the ML1 model 202, and approximately 1.6 million fraudulent approved transactions having a score (e.g., a fraud probability) of 0.4 generated by the ML1 model 202, and approximately 1.7 million non-fraudulent approved transactions having a score (e.g., a fraud probability) of 0.6 generated by the ML1 model 202.

In some embodiments, instead of the actual number of transactions, the first distribution 302 and the second distribution 304 may be generated based on densities of fraud probabilities (e.g., a count of non-fraudulent approved transactions with a specific fraud probability divided by an entire count of the non-fraudulent approved transactions) of their corresponding transactions. Likewise, the second distribution 304 may be generated using similar approaches that generate the first distribution 302.

By using the first distribution 302 and the second distribution 304, a first score threshold 306 and a second score threshold 308 for assigning labels to the declined transaction may be determined. In some embodiments, the first score threshold 306 may be determined based on score densities the first distribution 302 that is generated based on scores of non-fraudulent approved transactions. For example, the first score threshold 306 may be a point where 35% of the population of the non-fraudulent approved transactions correspond to the first score threshold 306 or below the first score threshold 306. Such point may be suitable to set as the first score threshold 306 for assigning a label that indicates a potentially approved transaction (e.g., a “good” label) for transaction. For example, for those transactions that have a score (determined by the ML1 model) lower than the first score threshold 306 may be assigned with the “good” label. In some embodiments, the first score threshold 306 may be a point where the population of the non-fraudulent approved transactions has the highest count in the first distribution 302. In some embodiments, the first score threshold 306 may be a point assigned by an administrator of the service provider based on a need and/or characteristics of the service, such as a point where a point where the highest density of the non-fraudulent approved transactions is. The highest density may indicate a score that the most population of the non-fraudulent approved transactions has, such that the score may be suitable to set as the first score threshold 306 for assigning a label that indicates a potentially approved transaction for transaction.

In a similar manner, the second score threshold 308 may be determined based on score densities the second distribution 304 that is generated based on scores of fraudulent approved transactions. For example, the second score threshold 308 may be a point where the highest density is. The highest density may indicate a score that the most population of the fraudulent approved transactions has, such that the score may be suitable to set as the second score threshold 308 for assigning a label that indicates a potentially declined transaction (e.g., a “bad” label) for transaction. For example, for those transactions that have a score (determined by the ML1 model) exceeding the second score threshold 308 may be assigned with the “bad” label. In some embodiments, the second score threshold 308 may be a point where the population of the fraudulent approved transactions has the highest count in the second distribution 304. In some embodiments, the second score threshold 308 may be a point assigned by an administrator of the service provider based on a need and/or characteristics of the service, such as a point where 35% of the population of the fraudulent approved transactions corresponds to the second score threshold 308 or above the second score threshold 308.

Furthermore, the first score threshold 306 and the second score threshold 308 may be used to determine a marginal score threshold 310. In some embodiments, the marginal score threshold 310 may be a midpoint of the first score threshold 306 and the second score threshold 308. The marginal score threshold 310 may be used to assign labels for transactions that have a score between the first score threshold 306 and the second score threshold 308. For example, the marginal score threshold 310 may indicate whether a transaction that has not been assigned with the “good” label or the “bad” label inclines to an approved transaction or a declined transaction.

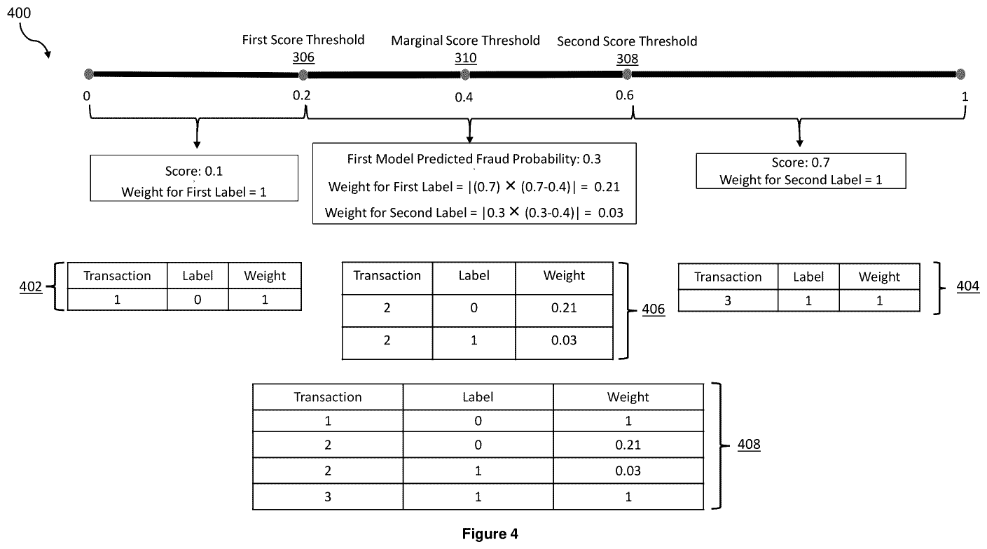

FIG. 4 illustrates an exemplary diagram 400 of inferring a label and a weight for a transaction, according to various embodiments of the disclosure. As discussed in FIG. 3, the first score threshold 306, the second score threshold 308, and the marginal score threshold 310 are used to infer a label (e.g., the “good” label or the “bad” label) for a transaction, and furthermore, infer a weight corresponding to the label for the transaction. For example, the label inferring module 122 may use the score thresholds 306, 310, and 308 to infer labels for the declined transactions 134 using techniques disclosed herein as illustrated by FIG. 4.

For preparing a record (e.g., a data point) for training the ML2 model, the ML1 model may generate a score (e.g., a fraud probability) for a transaction (e.g., a declined transaction that does not have a label) based on data associated with the transaction. Based on the score, the transaction may be assigned with a label and a weight. For example, the transaction may be assigned with a first label (e.g., a “good” label/a “good” tag) and a first weight by the label inferring module 122, when its score falls below the first score threshold 306. The transaction may be assigned with a second label (e.g., a “bad” label/a “bad” tag) and a second weight by the label inferring module 122, when its score exceeds the second score threshold 308. Furthermore, the transaction may be duplicated (e.g., oversampled) by the label inferring module 122, when its score falls between the first score threshold 306 and the second score threshold 308. Then the original transaction may be assigned with the first label and a first adaptive weight, and the duplicated transaction may be assigned with the second label and a second adaptive weight.

As shown in FIG. 4, an example process for inferring a label and a weight for various declined transactions 134 (e.g., a Transaction 1, a Transaction 2, and a Transaction 3, etc.) may be illustrated. In some embodiments, the process for inferring labels and weights may be performed by the label inferring module 122. In FIG. 4, the first score threshold 306 determined by a process discussed in FIG. 3 may be 0.2, the second score threshold 308 determined by a process discussed in FIG. 3 may be 0.6, and the marginal score threshold 310 may be 0.4 (e.g., the midpoint of the first score threshold 306 and the second score threshold 308). IN the example shown in FIG. 4, Transaction 1 has a score (e.g., a fraud probability predicted by the ML1 model 204) of 0.1, Transaction 2 has a score (e.g., a fraud probability predicted by the ML1 model 204) of 0.3, and Transaction 3 has a score (e.g., a fraud probability predicted by the ML1 model 204) of 0.7.

Since Transaction 1 has a score lower than the first score threshold 306, the label inferring module 122 may assign, to Transaction 1, a label tagged with a number zero indicating non-fraudulent transaction, and a first weight of one. In some embodiments, a prepared training data point for Transaction 1 may be shown as a first chart 402, including a label of zero and a weight of one. Since Transaction 3 that has a score higher than the second score threshold 308, the label referring module 122 may assign, to Transaction 3, a label tagged with a number one indicating a fraudulent transaction, and a second weight. In some embodiments, a prepared training data point for Transaction 3 may be shown as a second chart 404, including a label of one and a weight of one. Since Transaction 2 has a score between the first score threshold 306 and the second score threshold 308, the label inferring module 122 may first create a duplicated training data point based on the transaction data of Transaction 2. As a result of the oversampling, two training data points may be generate based on Transaction 2. The label inferring module 122 may assign, to one of the training data points (e.g., the original Transaction 2), the first label and may assign, to the other one of the training data points (e.g., the duplicated Transaction 2), the second label, as shown in chart 406. For the training data point that has been assigned with the first label, a first adaptive weight may be calculated by the label inferring module 122 based on a difference between the score generated for Transaction 2 and the marginal score threshold 310. For example, the first adaptive weight may be calculated using the expression |(1−score)×((1−score)−(marginal score threshold))|. In this example, the label inferring module 122 may calculate the adaptive weight for the first training data point of Transaction 2 as |(1−0.3)×((1−0.3)−0.4)|, which equals to 0.21. The label inferring module 122 may assign the weight of 0.21 to the original Transaction 2. For the duplicated Transaction 2 that has been assigned with the second label, a second adaptive weight may be calculated by the label inferring module 122 based on a difference between the score and the marginal score threshold 310. For example, the second adaptive weight may be calculated using the expression |(score)×((score)−(marginal score threshold)|. In this example, the label inferring module 122 may calculate the adaptive weight for the second training data point of Transaction 2 as |(0.3)×((0.3)−0.4)| which equals to 0.03. The label inferring module 122 may assign the weight of 0.03 to the duplicated Transaction 2. In some embodiments, a first training data point created based on Transaction 2 is shown in a third chart 406, including a label of zero (e.g., the first label) and its corresponding weight of 0.21. A second training data point created based on Transaction 2 is also shown in the third chart 406, including a label of one (e.g., the second label) and its corresponding weight of 0.03.

Once all the transactions have been assigned with labels and weights as discussed above, a training dataset as shown in a fourth chart 408 may be applied for training the ML2 model. Inferring labels and weights for those transactions (e.g., the declined transactions) that do not have verified labels may improve the usage of available resource and reduce subjective errors when training a model. Furthermore, assigning both labels and their adaptive weights may improve the accuracy and performance of the trained model to identify potential fraud transactions.

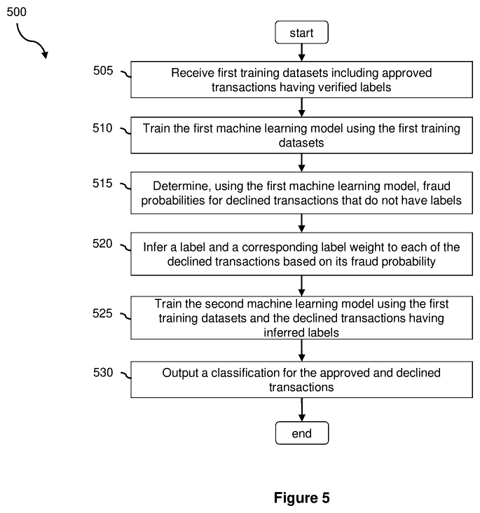

FIG. 5 illustrates an exemplary process 500 for training the ML2 model for performing rule agnostic reject inferencing according to various embodiments of the disclosure. In some embodiments, at least a portion of the process 500 may be performed by the label inferring module 122. The process 500 begins by receiving (at step 505) first training datasets including approved transactions having verified labels. For example, the first training datasets may be data associated with previous transactions that have been approved in the past, e.g., the transactions/applications approved by the fraud model and the credit model, and have been assigned with a “good” tag (e.g., the verified labels). In some embodiments, the approved transactions may include non-fraudulent approved transactions and fraudulent approved transactions. The non-fraudulent approved transactions may be transactions that have been approved by the fraud model and the credit model and have not later been reported as a fraudulent transaction. The fraudulent approved transactions may be transactions that have been approved by the fraud model and the credit model and have later been reported as a fraudulent transaction.

The process 500 trains (at step 510) a ML1 model using the first training datasets. The ML1 model is trained to predict fraud probabilities for declined transactions. In some embodiments, the declined transactions may include transactions that have been declined by the fraud model, and transactions that have been approved by the fraud model but have been declined by the credit model.

The process 500 determines (at step 515), using the ML1 model, fraud probabilities for declined transactions that do not have labels. For example, based on various factors included in the approved transactions, the ML1 model may predict a fraud probability for each transaction, including the approved transactions and the declined transactions.

The process 500 infers (at step 520) a label and a corresponding weight to each of the declined transactions based on its fraud probability. In some embodiments, the process 500 may generates a distribution of classifications that includes a first distribution of scores generated by the ML1 model based on the non-fraudulent approved transactions in the first training datasets (e.g., transactions classified as a good class). Furthermore, the distribution of classifications may further include a second distribution of scores generated by the ML1 model based on the fraudulent approved transactions in the first training datasets (e.g., transactions classified as a fraud class).

In some embodiments, the process 500 may utilize the non-fraudulent approved transactions and the fraudulent approved transactions to generate two population distributions based on their fraud probabilities. The population distribution of the non-fraudulent approved transactions may be used to determine a first score threshold (e.g., a “good” cutoff point for assigning a “good” label to a transaction that has a fraud probability lower than the “good” cutoff point) for determining the label and the corresponding weight for each of the declined transactions. In some embodiments, the first score threshold may be a point where the population of the non-fraudulent approved transactions has the highest density/count, a point assigned by an administrator of the service provider, or a point where the first 25% of the population of the non-fraudulent approved transactions is. The population distribution of the fraudulent approved transactions may be used to determine a second score threshold (e.g., a bad cutoff point for assigning a “bad” label to a transaction that has a fraud probability higher than the “bad” cutoff point) for determining the label and the corresponding weight for each of the declined transactions. In some embodiments, the second score threshold may be a point where the population of the fraudulent approved transactions has the highest density/count, a point assigned by an administrator of the service provider, or a point where the first 75% of the population of the non-fraudulent approved transactions is. Furthermore, the first score threshold and the second score threshold may be used to determine a marginal score threshold that may be used to determine the label and the corresponding weight for each of the declined transactions. In some embodiments, the marginal score threshold may be a midpoint of the first score threshold and the second score threshold. For example, when the first score threshold is a fraud probability of 0.3 and the second score threshold is a fraud probability of 0.7, the marginal score threshold may be 0.5.

In some embodiments, the process 500 may infer the label by generating a first score using the ML1 model based on a first transaction record (e.g., a history transaction that has been declined) in second training datasets (e.g., training datasets that include declined transactions in the past without labels), and assigning a first label to the first transaction record when the first score falls below the first score threshold or assigning a second label to the first transaction record when the first score exceeds the second score threshold.

For each transaction that has a score (e.g., a fraud probability) below the first score threshold, the process 500 assigns a first label (e.g., assigning zero to a “bad” tag) for these transactions. For each transaction that has a score (e.g., a fraud probability) higher the second score threshold, the process 500 assigns a second label (e.g., assigning one to a “bad” tag) for these transactions. For each transaction that has a score (e.g., a fraud probability) between the first score threshold and the second score threshold, the process 500 generates a duplicated transaction, and assigns the first label to the original transaction and the second label for the duplicated transaction. For example, for those transactions that have a score between the first score threshold and the second score threshold, those transactions could be either a non-fraudulent transaction or a fraudulent transaction, so that assigning both labels (e.g., representing both “good” class and fraud class) to those transactions and calculating an adaptive weight for each label are beneficial to indicate whether such a transaction is more leaning toward a “good” class or a fraud class.

Furthermore, in some embodiments, for each transaction that has a score below the first score threshold, the process 500 calculates a first weight for these transactions. For example, the first weight may be one or any fixed number to represent a weight for the first label (e.g., a “good” class). For each transaction that has a score higher the second score threshold, the process 500 assigns a second weight for these transactions. For example, the second weight may one or any fixed number (that is corresponding to the number for the first label) to represent a weight for the second label (e.g., a fraud class). For transactions that have a score (e.g., a fraud probability) between the first score threshold and the second score threshold, the process 500 calculates a first adaptive weight for the original transaction assigned with the first label (e.g., a “good” class), and a second adaptive weight for the duplicated transaction assigned with the second label (e.g., a fraud class). For example, the process 500 may further utilize the marginal score threshold 308 to calculate the first adaptive weight and the second adaptive weight, because the difference between the score and the marginal score threshold may indicate the relevance of the transaction to the “good” class or the fraud class (e.g., when the weight of the first label is higher than the weight of second label, it may indicate that the transaction is more relevant to a “good” class). In some embodiments, the process 500 may apply oversampling to the declined transactions, especially the declined transactions that have a score between the first score threshold and the second score threshold, such that they (e.g., the less confident record) may be seen as both positive and negative with appropriate weights assigned to them.

In some embodiments, the first adaptive weight may be calculated using (1−α)×|(1−α)−(Marginal Score Threshold)|, where a is the score of the transaction generated by the ML1 model. The second adaptive weight may be calculated using α×|α−(Marginal Score Threshold)|, where a is the score of the transaction generated by the ML1 model.

In some embodiments, the first adaptive weight and the second adaptive weight may be calculated using:

$$Loss Function = - \frac{1}{n} {\sum }_{i = 1}^{n} ( {y}_{i} log ( {p}_{i} ) + ( 1 - {y}_{i} ) log ( 1 - {p}_{i} ) ) \times Row {Weight}_{i}$$

$${Q}_{1 , AG} = 25 th percentile of ( Probabilities of Approved Good )$$

$${Q}_{3 , AB} = 75 th percentile of ( Probabilities of Approved Bad )$$

$$Row Weight ( p , y ) = \{ \begin{matrix}p \cdot \vert p - \frac{\text{?}}{2} \vert , & if y = 1 and {Q}_{1 , AG} < p < {Q}_{3 , AB} \\ ( 1 - p ) \cdot \vert ( 1 - p ) - \frac{\text{?}}{2} \vert , & if y = 0 and {Q}_{1 , AG} < p < {Q}_{3 , AB} \\ 1 , & otherwise\end{matrix}$$

$$\text{?} \text{indicates text missing or illegible when filed}$$

The process 500 trains (at step 525) the M2 machine learning model using the first training datasets and the declined transactions having inferred labels. For example, the ML2 machine learning model may be trained using the approved transactions with the verified labels (as discussed at step 505) and the declined transactions with the labels and weights inferred at step 520. The ML2 machine learning model may be trained to output a classification for a transaction.

The process 500 outputs (at step 530) a classification for the approved and declined transactions. In some embodiments, the classification may include a non-fraudulent approved classification, a fraudulent approved classification (e.g., a fraudulent transaction that might have been wrongfully approved), and a declined classification. The service provider may set up classifications based on a need of the service, e.g., an approved classification and a declined classification.

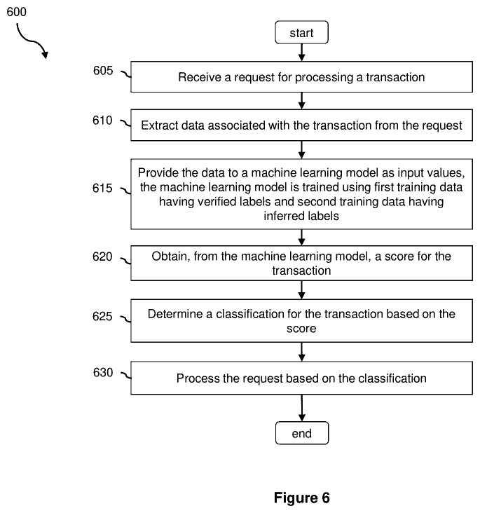

FIG. 6 illustrates an exemplary process 600 for performing a classification task using a machine learning model using the rule-agnostic reject inferencing techniques according to various embodiments of the disclosure. In some embodiments, at least a portion of the process 600 may be performed by the fraud predicting module 124. The process 600 begins by receiving (at step 605) a request for processing a transaction. The request may include data associated with the user 150 and/or the user device 110, data associated with the server 120 and/or the merchant server 160 that performs the transaction, and/or history data associated with the transaction.

The process 600 extracts (at step 610) data associated with the transaction from the request. In some embodiments, the process 600 may include a step to retrieve the history data associated with the transaction based on the data extracted from the request.

The process 600 provides (at step 615) the data to a machine learning model as input values. The machine learning model may be trained using first training data having verified labels and second training data having inferred labels. In some embodiments, the machine learning model may be trained using the process 500 discussed in FIG. 5.

The process 600 obtains (at step 620), from the machine learning model, a score for the transaction. For example, the machine learning model may obtain the score for the transaction based on the data associated with the request, including, e.g., a user profile, a transaction history associated with the user, and/or regulations associated with a service performing the transaction.

The process 600 determines (at step 625) a classification for the transaction based on the score. In some embodiments, classifications may include a first classification (e.g., the approved classification) and a second classification (e.g., the declined classification). The first classification may correspond to non-fraudulent transactions, and the second classification may correspond to fraudulent transactions. Based on the score, the process 600 may classify the transaction into one of the classifications, e.g., the approved classification or the declined classification.

The process 600 processes (at step 630) the request based on the classification. For example, the process 600 may approve the request and complete the transaction when the transaction have been classified as the approved classification. Otherwise, the process 600 may decline the request when the transaction have been classified as the declined classification.

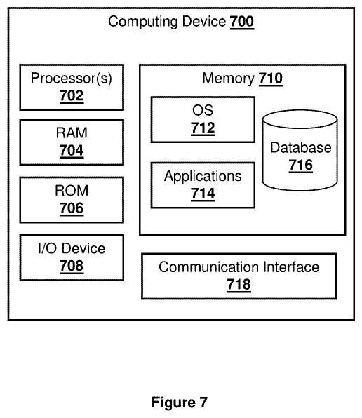

FIG. 7 illustrates a computing device 700 that may be used to implement the server 120, the user device 110, and the datasets database 130 according to various embodiments of the disclosure. For example, the computing device 700 may be the server 120 performing the actions disclosed in FIGS. 2 to 6. The computing device 700 may include a processor 702 for controlling overall operation of the computing device 700 and its associated components, including a random access memory (RAM) 704, a read only memory (ROM) 706, an input/output (I/O) device 708, a communication interface 718, and/or a memory 710. A data bus may interconnect the processor(s) 702, the RAM 704, the ROM 706, the memory 710, the I/O device 708, and/or the communication interface 718. In some embodiments, the computing device 700 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

The input/output (I/O) device 708 may include a microphone, keypad, touch screen, and/or stylus motion, gesture, through which a user of the computing device 700 may provide input. The I/O device 708 may also include one or more of a speaker for providing audio output and a video display device for providing textual, audiovisual, and/or graphical output. Software may be stored within the memory 710 to provide instructions to the processor(s) 702 allowing the computing device 700 to perform various actions. For example, the memory 710 may store software used by the computing device 700, such as an operating system (OS) 712, application programs 714, an associated internal database 716, and/or any software that implements the process 600 as described herein. The various hardware memory units in the memory 710 may include volatile and nonvolatile, removable and non-removable media implemented in any method or technology for storage of information such as computer-readable instructions, data structures, program modules, or other data. The memory 710 may include one or more physical persistent memory devices and/or one or more non-persistent memory devices. The memory 710 may include, but is not limited to, a RAM, a ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor(s) 702.

The communication interface 718 may include one or more transceivers, digital signal processors, and/or additional circuitry and software for communicating via any network, wired or wireless, using any protocol as described herein.

The processor(s) 702 may include a single central processing unit (CPU), e.g., a single-core or multi-core processor, or may include multiple CPUs. The processor(s) 702 and associated components may allow the computing device 700 to execute a series of computer-readable instructions to perform some or all of the processes described herein. Although not shown in FIG. 7, various elements within the memory 710 or other components in computing device 700, may include one or more caches, for example, CPU caches used by the processor(s) 702, page caches used by the operating system 712, disk caches of a hard drive, and/or database caches used to cache content from the database 716. In various embodiments, the database 716 may be the datasets database 130 described in FIG. 1. For embodiments including a CPU cache, the CPU cache may be used by the processor(s) 702 to reduce memory latency and access time. The processor(s) 702 may retrieve data from or write data to the CPU cache rather than reading/writing to the memory 710, which may improve the speed of these operations. In some embodiments, a database cache may be created in which certain data from the database 716 is cached in a separate smaller database in a memory separate from the database 716, such as in the RAM 704 or on a separate computing device. For instance, in a multi-tiered application, a database cache on an application server may reduce data retrieval and data manipulation time by not needing to communicate over a network (e.g., the network 140 described in FIG. 1) with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 700 are described separately, functionality of the various components may be combined and/or performed by a single component and/or multiple computing devices in communication without departing from the invention.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled with the non-transitory memory and configured to read instructions from the non-transitory memory to cause the system to perform operations comprising:
receiving a request for processing a transaction;
determining, using a first machine learning model, a classification for the transaction based on data associated with the transaction, wherein the first machine learning model is trained using first training data having verified labels and second training data having inferred labels, and wherein the inferred labels of the second training data are generated based on a distribution of classifications associated with the first training data; and
processing the request based on the classification.

2. The system of claim 1, wherein the classifications include a first classification and a second classification, wherein the first classification corresponds to non-fraudulent transactions, and the second classification corresponds to fraudulent transactions.

3. The system of claim 1, wherein the distribution of classifications comprises a first distribution of scores generated by a second machine learning model for first transactions associated with a first portion of the first training data classified as a first classification, wherein the distribution of classifications further comprises a second distribution of scores generated by the second machine learning model for second transactions associated with a second portion of the first training data classified as a second classification, and wherein the second machine learning model was trained based on the first training data, and not the second training data.

4. The system of claim 1, wherein the operations further comprise:
determining a first score threshold and a second score threshold based on the distribution of classifications; and
inferring, for each transaction record in the second training data, a label based on at least the first score threshold and the second score threshold.

5. The system of claim 4, wherein the inferring the label comprises:
generating a first score using a second machine learning model based on a first transaction record in the second training data; and
assigning a first label to the first transaction record when the first score falls below the first score threshold or assigning a second label to the first transaction record when the first score exceeds the second score threshold.

6. The system of claim 4, wherein the inferring the label comprises:
generating a second score using a second machine learning model based on a second transaction record in the second training data;
in response to determining that the second score falls between the first score threshold and the second score threshold, generating a duplicated second transaction record;
assigning a first label and a first weight to the second transaction record; and
assigning a second label and a second weight to the duplicated second transaction record.

7. The system of claim 1, wherein the first training data includes previous transactions that have been approved, and the second training data includes previous transactions that have been declined.

8. A method, comprising:
receiving a request for processing a transaction;
accessing a first machine learning model trained using first training data having verified labels and second training data having inferred labels, wherein the inferred labels of the second training data were generated using a second machine learning model based on a distribution of classifications associated with the first training data, and wherein the second machine learning model was trained using the first training data having the verified labels;
determining, using the first machine learning model, a classification for the transaction based on data associated with the transaction; and
processing the request based on the classification.

9. The method of claim 8, wherein the classifications include a first classification and a second classification, wherein the first classification corresponds to non-fraudulent transactions, and the second classification corresponds to fraudulent transactions.

10. The method of claim 8, wherein the distribution of classifications comprises a first distribution of scores generated by the second machine learning model for first transactions associated with a first portion of the first training data classified as a first classification, wherein the distribution of classifications further comprises a second distribution of scores generated by the second machine learning model for second transactions associated with a second portion of the first training data classified as a second classification, and wherein the second machine learning model was trained based on the first training data, and not the second training data.

11. The method of claim 8, further comprising:
determining a first score threshold and a second score threshold based on the distribution of classifications; and
inferring, for each transaction record in the second training data, a label based on at least the first score threshold and the second score threshold.

12. The method of claim 11, wherein the inferring the label comprises:
generating a first score using the second machine learning model based on a first transaction record in the second training data; and
assigning a first label to the first transaction record when the first score falls below the first score threshold or assigning a second label to the first transaction record when the first score exceeds the second score threshold.

13. The method of claim 11, wherein the inferring the label comprises:
generating a second score using the second machine learning model based on a second transaction record in the second training data;
in response to determining that the second score falls between the first score threshold and the second score threshold, generating a duplicated second transaction record;
assigning a first label and a first weight to the second transaction record; and
assigning a second label and a second weight to the duplicated second transaction record.

14. The method of claim 8, wherein the first training data includes previous transactions that have been approved, and the second training data includes previous transactions that have been declined.

15. A non-transitory machine-readable medium having stored thereon machine-readable instructions executable to cause a machine to perform operations comprising:
receiving a request for processing a transaction;
determining, using a first machine learning model, a classification for the transaction based on data associated with the transaction, wherein the first machine learning model was trained using first training data having verified labels and second training data having inferred labels and corresponding weights, and wherein the inferred labels of the second training data were generated based on a distribution of classifications associated with the first training data, and each of the inferred labels include a corresponding weight to indicate a level of inclination towards to its respective inferred label; and
processing the request based on the classification.

16. The non-transitory machine-readable medium of claim 15, wherein the classifications include a first classification and a second classification, wherein the first classification corresponds to non-fraudulent transactions, and the second classification corresponds to fraudulent transactions.

17. The non-transitory machine-readable medium of claim 15, wherein the distribution of classifications comprises a first distribution of scores generated by a second machine learning model for first transactions associated with a first portion of the first training data classified as a first classification, wherein the distribution of classifications further comprises a second distribution of scores generated by the second machine learning model for second transactions associated with a second portion of the first training data classified as a second classification, and wherein the second machine learning model was trained based on the first training data, and not the second training data.

18. The non-transitory machine-readable medium of claim 15, wherein the operations further comprise:
determining a first score threshold and a second score threshold based on the distribution of classifications; and
inferring, for each transaction record in the second training data, a label based on at least the first score threshold and the second score threshold.

19. The non-transitory machine-readable medium of claim 18, wherein the inferring the label comprises:
generating a first score using a second machine learning model based on a first transaction record in the second training data; and
assigning a first label to the first transaction record when the first score falls below the first score threshold or assigning a second label to the first transaction record when the first score exceeds the second score threshold.

20. The non-transitory machine-readable medium of claim 18, wherein the inferring the label comprises:
generating a second score using a second machine learning model based on a second transaction record in the second training data;
in response to determining that the second score falls between the first score threshold and the second score threshold, generating a duplicated second transaction record;
assigning a first label and a first weight to the second transaction record; and
assigning a second label and a second weight to the duplicated second transaction record.
